(19) United States
(12) Patent Application Publication
(10) Pub. No.: US 2020/0167774 A1
(43) Pub. Date: May 28, 2020

(54) SYSTEMS AND METHODS FOR OPTIMIZED RETAIL MESSAGE AUTHENTICATION CODE PROCESSING

(71) Applicant: MASTERCARD INTERNATIONAL INCORPORATED, PURCHASE, NY (US)

(72) Inventor: Mehdi Collinge, Mont-Sainte-Aldegonde (BE)

(21) Appl. No.: 16/683,421

(22) Filed: Nov. 14, 2019

Related U.S. Application Data
(60) Provisional application No. 62/772,539, filed on Nov. 28, 2018.

(51) Int. Cl. G06Q 20/38; H04L 9/32; H04L 9/06

(52) U.S. Cl. CPC G06Q 20/3829; G06Q 20/3823; H04L 9/0625; H04L 9/0637; H04L 9/3242

(57) ABSTRACT

According to some embodiments, systems, methods and computer program code are provided to generate a retail message authentication code (MAC) which includes loading a first key, loading a second key, issuing a first call to a cloud hardware security module (HSM) to invoke a DES3 encryption operation, the call including the first key and a first input set of data, receiving an output of the first call, issuing a second call to a cloud HSM to invoke a DES3 encryption operation, the call including the second key and a second input set of data, the second input set of data including data associated with the output of the first call, receiving the generated retail MAC.

### RELATED APPLICATIONS

This application is based on and claims benefit of and priority to U.S. Provisional Patent Application Ser. No. 62/772,539 filed on Nov. 28, 2018, the contents of which are hereby incorporated in their entirety for all purposes.

### BACKGROUND

The cloud computing market is expanding rapidly. More and more businesses are shifting some or all of their computing workloads to cloud services such as Amazon Web Services (“AWS”), Google Cloud Platform (“GCP”), Microsoft Azure (“Azure”) or the like. Businesses appreciate the reduced infrastructure cost and other conveniences offered by these cloud service providers. Cloud service provides are increasingly offering application services including security services. For example, cloud service providers offer hardware security modules (“HSM”) as a service.

As a specific example, the HSM services offered by AWS is a cloud-based HSM that allows users to generate and use their own encryption keys in the AWS cloud. The AWS HSM is a fully-managed service that automates hardware provisioning, software patching and backups, and also provides a high-availability infrastructure. These cloud HSMs may be an attractive option to businesses that wish to scale quickly with no up-front costs.

One example of a type of industry that uses HSMs is the payment industry. Many payment transactions require the use of security infrastructure including HSMs to support secure transactions. One specific example of a type of cryptographic function that is used in payment transactions is the generation of message authentication codes (or “MACs”) pursuant to ISO/IEC 9797-1. The standard defines a general model from which a variety of algorithms can be constructed. The model is based on a block cipher with a secret symmetric key. One of the algorithms specified is referred to as a “Retail MAC” (or, as referenced in ISO/IEC 9797-1, “MAC Algorithm 3”). The Retail MAC algorithm uses a combination of digital encryption standard (“DES”) and Triple DES (“DES3”). Retail MACs have been used in payment transactions and are commonly used in payment specifications such as those available at www.emvco.com. Because of the widespread adoption of these payment specifications, the use of Retail MACs is ingrained in payment processing infrastructure.

Cryptographic techniques frequently are updated and improved. For example, the cryptographic techniques used in Retail MACs are now generally obsolete have been removed from the list of approved algorithms (Federal Information Processing Standards Publication (FIPS) 140-2) and have been replaced by more advanced algorithms. The result is that existing infrastructure may continue to support cryptographic techniques that while still secure have been deprecated. Unfortunately, cloud HSM providers typically must support non-deprecated, current techniques. As a result, it is generally not possible to use cloud HSMs to support legacy use cases where the legacy use cases involve deprecated cryptographic techniques.

It would be desirable to allow cloud HSMs to perform cryptographic processing in support of legacy use cases that use deprecated cryptographic techniques.

### SUMMARY OF THE INVENTION

According to some embodiments, systems, methods and computer program code are provided to generate a retail message authentication code (“MAC”) which may be used with cloud hardware security modules (“HSM”). Pursuant to some embodiments, systems, methods and computer program code are provided to generate a retail message authentication code (MAC) which includes loading a first key, loading a second key, issuing a first call to a cloud hardware security module (HSM) to invoke a DES3 encryption operation, the call including the first key and a first input set of data, receiving an output of the first call, issuing a second call to a cloud HSM to invoke a DES3 encryption operation, the call including the second key and a second input set of data, the second input set of data including data associated with the output of the first call, receiving the generated retail MAC.

In some embodiments, some of the operations may be threaded to improve performance. For example, in some embodiments the first input set of data is created prior to issuing the first call, and the first input set of data includes data associated with a payment transaction. The second input set of data is created prior to issuing the second call. A first threaded operation may be initiated which thread includes loading the first key, creating the first input set of data, issuing the first call, receiving the output of the first call and obtaining the data associated with the output of the first call. A second threaded operation may also be initiated (e.g., substantially in parallel with the initiation of the first threaded operation) which includes loading the second key and creating the second input set of data. The second cloud HSM encryption call is issued after completion of the first and second threaded operations.

A technical effect of some embodiments of the invention is an improved and optimized way for cloud HSMs to perform Retail MAC processing such that the cloud HSMs may be compatible with legacy infrastructure. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a block diagram of a system pursuant to some embodiments.

FIG. 2 is a block diagram depicting a key hierarchy associated with a prior art payment scheme.

FIG. 3 is a block diagram depicting a prior art Retail MAC process.

FIG. 4 is a block diagram depicting an optimized Retail MAC process pursuant to the present invention.

FIG. 5 is a block diagram of an apparatus in accordance with some embodiments of the present invention.

FIG. 6. is a process diagram of a process pursuant to some embodiments.

### DETAILED DESCRIPTION

In general, and for the purpose of introducing concepts of embodiments of the present disclosure, embodiments provide systems, methods and computer program code to method to generate a Retail MAC code which may be used with cloud hardware security modules (“HSM”).

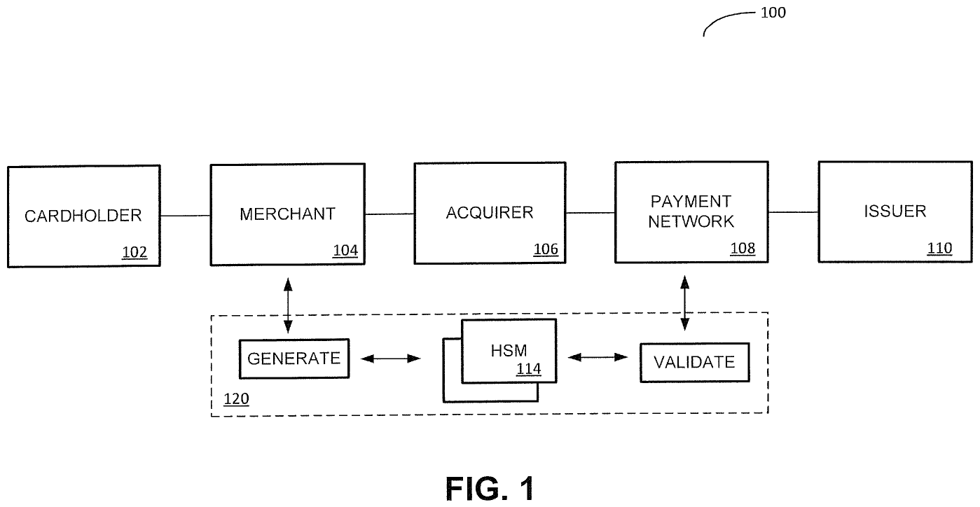

FIG. 1 is a block diagram that illustrates a system 100 in which the present invention may be applied. For illustrative purposes, features of the present invention will be described in the context of a payment transaction involving a cardholder 102 interacting with a merchant 104 using a payment device such as, for example, a payment enabled mobile device, a contactless or a contact payment card, or the like. The transaction may follow a standard four-party payment flow in which the cardholder 102 interacts with a merchant 104, and the merchant 104 transmits a payment authorization request message to an acquirer 106. The acquirer 106 interacts with a payment network 108 (such as, for example, the Banknet network operated by the assignee of the present application) to transmit the payment authorization request message to the issuer 110 associated with the payment device presented by the cardholder 102 in the transaction.

In general, the transaction will be described as one involving payment cards configured pursuant to the specifications promulgated by EMVCo and available at http://www.emvco.com. Those skilled in the art, upon reading the present disclosure will appreciate that features of the present invention may be used with desirable results in other types of transactions and in transactions involving other types of devices.

As shown, the system 100 further includes a merchant 104 in communication with the cardholder 102. Although only a single cardholder 102 and merchant 104 are depicted, the system 100 likely involves a multitude of both devices or entities. For example, a number of cardholders (using a number of payment devices) may interact with a variety of different merchants 104 to facilitate transactions pursuant to the present invention. An interaction between a cardholder 102 and a merchant 104 may be, for example, a remote interaction such as, for example, a wireless interaction over a network interface. For example, the cardholder 102 may operate a mobile device to interact with the merchant 104 to conduct a purchase transaction over a communication network using a protocol such as HTTP (HyperText Transfer Protocol) or the like. In some embodiments, the communication between the cardholder 102 and the merchant 104 may be facilitated or controlled via a mobile application installed on a mobile device (e.g., such as, for example, a merchant application on the mobile device).

Pursuant to some embodiments, transactions are processed using a secure payment protocol which may be referred to herein as the Digital Secure Remote Payment (“DSRP”) protocol which provides improved fraud prevention (which, in some embodiments, may allow reduced fraud liability for the merchant). Transactions involving the DSRP protocol require cryptographic processing support. As shown in FIG. 1, some or all of the cryptographic processing support may be provided by one or more payment services 120. The payment services 120 may be accessible to merchants 104, the payment network 108 and other entities in the payment system that need cryptographic and other support services, and may be accessible via, for example, a secured application programming interface (API) or the like. For example, the merchant 104 may interact with the payment services 120 to obtain generated transaction credentials that can then be used in conjunction with the authorization request transmitted to the acquirer 106.

Pursuant to the present invention, the payment services 120 may include (or be in communication with) one or more cloud HSMs 114 configured to operate as described further herein. For example, in some embodiments, the function to generate transaction credentials (on request from the merchant 104) may be operated in the cloud as a payment service 120 and will further interact with one or more cloud HSMs 114 to secure the process and perform cryptographic operations. For example, in a DSRP transaction, there are Application Cryptogram (“AC”) generation and validation steps during a transaction. Each AC generation or AC validation requires the generation of two cryptograms. Pursuant to the present invention, the cloud HSM 114 is used to generate those cryptograms as will be discussed further herein.

When the generated transaction credentials are provided to the merchant 104, the merchant provides those credentials along with other transaction information to the acquirer 106 in conjunction with a payment authorization request message. The acquirer 106 routes the authorization request message via a payment network 108 for further processing and for delivery to the issuer 110 (or to an agent of the issuer 110).

The payment network 108 may interact with the payment services 120 to validate the transaction credentials received in conjunction with the authorization request message. The validation of transaction credentials may be performed as a service using one or more cloud HSMs 114 which are used to secure the process and perform cryptographic operations. Once the payment network 108 has validated the transaction credentials, the payment network 108 may route the authorization request message to the issuer 110 associated with the payment card used in the transaction for authorization. In prior transaction processing architectures, the generation and validation of transaction credentials were performed using non-cloud based HSMs as described elsewhere herein.

Pursuant to the present invention, some of the cryptographic processing support may be provided by one or more security modules in a cloud computing environment (e.g., such as the cloud HSM 114). The cloud HSM 114 may be provided by, for example, a cloud service provider such as AWS, GCP or Azure. Although only a single cloud HSM 114 is shown, those skilled in the art, upon reading the present disclosure, will appreciate that a number of cloud HSMs 114 may be provided to support a number of transactions. For example, in some embodiments, a cluster of cloud HSMs 114 may be provided in one or more geographical regions to provide high availability and redundant operation sized to accommodate the expected number of transactions.

The components of the system 100 as depicted in FIG. 1 are only those that are needed for processing a single transaction. A typical practical embodiment of the system 100 may process many purchase transactions (including simultaneous transactions) and may include a considerable number of payment card issuers and their computers, a considerable number of acquirers and their computers, and numerous merchants and their merchant servers and associated components. The system may also include a very large number of payment cardholders, who carry payment-enabled mobile devices and/or payment cards (including contactless payment cards).

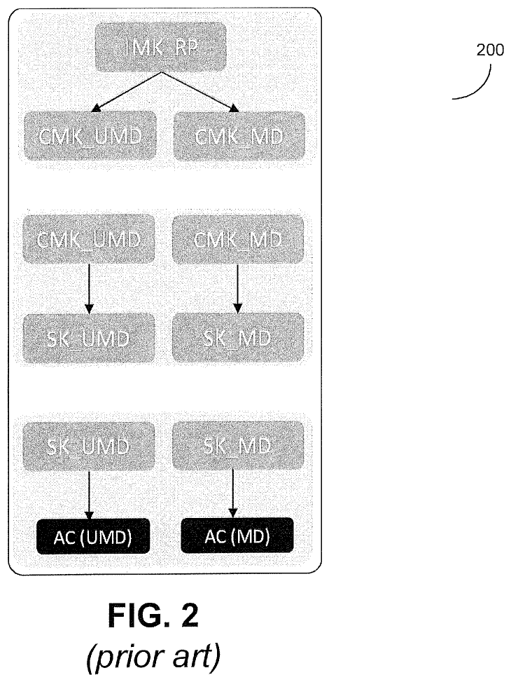

Features of some embodiments will now be described by reference to an existing remote payment scheme compliant with the EMV specifications that commonly uses specially configured hardware security modules. In particular, the payment scheme is the DSRP scheme referenced above. DSRP requires a cryptographic key hierarchy 200 as shown in FIG. 2. The Issuer Master Key (IMK) can be used to derive two Card Master Keys (CMK), CMK_UMD and CMK_MD where (1) the Mobile Device Authentication key is referenced as “MD” key, and (2) the User and Mobile Device Authentication key is referenced as “UMD” key. In general, in a DSRP environment, the derivation process is the same for both keys and the difference between the keys is at the level of the input data.

Further, Each Card Master Key (CMK_xx) can be derived to generate Session Keys (SK_xx). In a simplified view, to some extent, the derivation process for the session keys (SK_x) can be considered as similar (from a core crypto function point of view) to the derivation process used for CMK_xx derivation where the difference between the session keys is at the level of the input data. Further details of key management in the DSRP protocol can be found in the EMV specifications referenced above. In the following discussion, the details are summarized.

The notation IMK_xx and CMK xx_yyy is adopted in this section where xx denotes RP (Remote Payment) and yyy can be UMD or MD. Card master keys (“CMK”) are generated using Triple DES (or “DES3”). More particularly, the Card Master Keys CMK_xxyyy are derived using a process that corresponds to Method A as specified in EMV Book 2. The Card Master Key CMK_xxyyy is derived from the corresponding Issuer Master Key IMK_xx as follows: (i) CMKLEFT=DES3(IMK_xx)[Y], (ii) CMKRIGHT=DES3(IMK_xx)[Y XOR ‘FFFFFFFFFFFFFFFF’], and (iii) CMK_xx_yyy=CMK_{LEFT}∥CMK_{RIGHT}, where DES3 is a 2-key Triple DES Encryption using electronic codebook (“ECB”) mode and Y is an 8-byte value constructed using PAN (Primary Account Number) and PSN (PAN Sequence Number) values.

Session keys (SKs) may also be generated using DES3. For example, Session Keys (SK) may be derived from their corresponding Card Master Keys using the EMV Common Session Key (CSK) method specified in section A1.3.1 of EMV Book 2. The Session Keys SK_RP_yyy are derived from the Card Master Keys CMK RP_yyy where yyy can be UMD or MD. A session key SK is derived from the corresponding Card Master Key CMK in conjunction with the Application Transaction Counter (ATC, a 2-byte hexadecimal value that is unique to the transaction) as follows: (i) SK_{LEFT}=DES3 (CMK) [ATC∥‘F0’∥‘00’∥‘00’∥‘00’∥‘00’∥‘00’], (ii) SK_{RIGHT}=DES3 (CMK) [ATC∥‘0F’∥‘00’∥‘00’∥‘00’∥‘00’∥‘00’], (iii) SK=SK_{LEFT}∥SK_{RIGHT}, where DES3 is a 2-key Triple DES Encryption using ECB mode. Some payment networks and payment systems require that Session Keys used in certain solutions are not adjusted for parity and not checked for parity.

The EMV specifications require the generation of Application Cryptograms (“AC”) in many transactions, including transactions in Digital Secure Remote Payments (“DSRP”) which use data from transaction messages referred to as “UCAF” data. The generation of an AC requires access to cryptographic functions. For example, the generation of AC RP UMD and AC RP MD requires access to crypto functions as follows. First, a 39 byte buffer is created where the buffer is formed from: dsrpAmountAuthorized (6 bytes)∥dsrpAmountOther (6 bytes)∥ dsrpTerminalCountryCode (2 bytes)∥ dsrpTVR (5 bytes)∥dsrpTransactionCurrencyCode (2 bytes)∥ dsrpTransactionDate (3 bytes)∥dsrpTransactionType (1 byte)∥dsrpUN (4 bytes)∥dsrpAIP (2 bytes)∥dsrpATC (2 bytes)∥dsrpCVR (6 bytes).

The Application Cryptograms (ACs) are generated using a cryptographic computation using the buffer, a padding process and the session keys (SK_RP_UMD and SK_RP_MD), where (i) AC_RP_UMD=MAC(SK_RP_UMD)[buffer] and (ii) AC_RP_MD=MAC(SK_RP_MD)[buffer].

The values AC_RP_UMD and AC_RP_MD must be integrated in the template defined for UCAF Format 0 (dsrpUCAFFormat0) using an Application Cryptogram (AC) data object (8 bytes) constructed using: (i) the leftmost 4 bytes of the AC data object are equal to Byte [1-4] of AC_RP_MD, and (ii) the rightmost 4 bytes of the AC data object are equal to Byte [5-8] of the AC_RP_UMD. When using DES3 to generate the ACs, the padding is done using ‘80’ followed by ‘00’ to create a multiple of 8 bytes. MAC is a 2-key Triple DES CBC MAC ISO/IEC 9797-1 alg=3 pad=2 (80 pad). The cryptographic process to validate an AC is similar to the generation of the AC. Instead of delivering the application cryptograms (ACs) the function is expected to check the values against the supplied ACs.

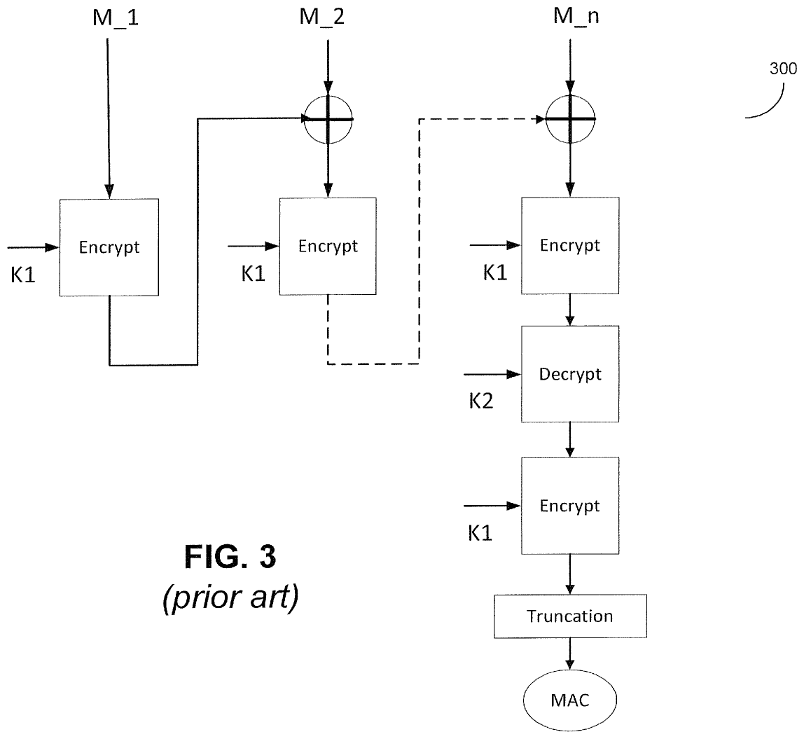

Reference is now made to FIG. 3, where a process 300 is shown to perform a prior art Retail MAC computation as defined in ISO/IEC 9797-1, algorithm 3, pad=2 (80 pad). FIG. 3 will be described in the context of a payment transaction which is processed using UCAF (DE48SE43) by a legacy hardware security module (which has not deprecated the use of DES). In general, the process proceeds as follows.

If we consider the 40 bytes of padded data to be processed when using UCAF (DE48SE43), we can expect the following standard use of a legacy HSM (which supports DES processing, and when Retail MAC is not delivered as a standard crypto function). First, Load Key K1 where K1 is the 8 bytes (left) of the key used to generate the AC. Next, load Key K2 where K2 is the 8 bytes (right) of the key used to generate the AC. Now, the Retail MAC is computed as follows: (i) prepare input for DES Call #1 (Encryption using CBC mode) using M (padded buffer) and IV set to 0s, (ii) DES call #1 (DES Encryption CBC) with n (n=5) core DES encryption operation done by the HSM using K1, (iii) prepare input for DES Call #2 using output of DES Call #1, (iv) DES call #2 (DES Decryption CBC/ECB) with 1 core DES decryption operation done by the HSM using K2, (v) prepare input for DES Call #3 using output of DES Call #2, (vi) DES call #3 (DES Encryption CBC/ECB) with 1 core DES encryption operation done by the HSM using K1 Then, the operation is completed by unloading Key K1 and Key K2. That is, in a prior art Retail MAC computation process, the use of DES is required. Cloud HSMs that are NIST compliant are unable to perform such processing (as DES is not supported by such cloud HSMs).

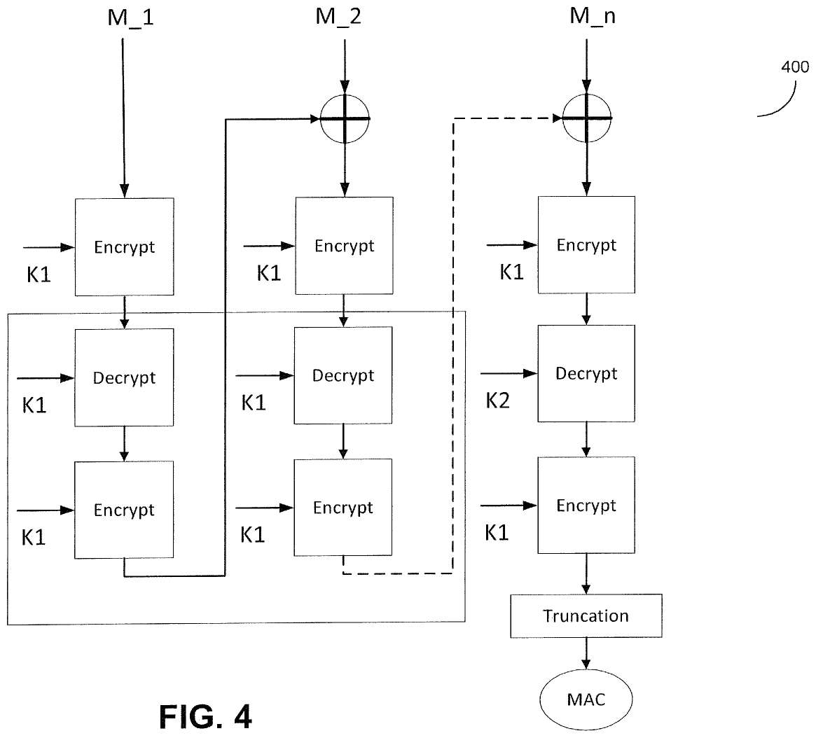

Reference is now made to FIG. 4 where a process 500 to generate a Retail MAC code using cloud HSMs 114 is shown. More particularly, process 500 depicts a process to generate Retail MAC codes using HSMs or cryptographic equipment in which DES has been deprecated. Pursuant to the present invention, the process for generating a Retail MAC code is streamlined and designed to function with cloud HSMs 114 including those cloud HSMs 114 that have deprecated some or all support for DES operations. As a specific example, the cloud HSMs offered by AWS support only DES3 3-key (not single DES). In the process 500 depicted in FIG. 4, a Retail MAC code is computed as follows (again, using the transaction example of a payment transaction as described above).

First, a Key K1K1K1 is loaded, where K1 is the 8 bytes (left) of the key used to generate the AC. Next a Key K1K2K1 is loaded, where K1 is the 8 bytes (left) and K2 is the 8 bytes (right) of the key used to generate the AC. The Retail MAC is then computed as follows. First, the input for DES3 Call #1 is prepared (where Call #1 is encryption using CBC mode of operation) using M_1|M_2| . . . |M_n-1 (excluding the rightmost 8 bytes of padded buffer) and the IV set to 0s. Call #1 is then made, which is a DES3 (DES3 Encryption in CBC mode of operation) with n (n=4) core DES3 encryption operation done by the HSM 114 using K1K1K1.

Next, the input for DES Call #2 is prepared using the output of DES Call #1 and M_n (the rightmost 8 bytes of the padded buffer). The second call (Call #2) is then made, which is a DES3 encryption call in the CBC mode of operation with 1 core DES3 encryption operation done by the HSM 114 using K1K2K1. The Key K1K1K1 is then unloaded. And then the Key K1K2K1 is unloaded.

The processing required is straightforward and allows cloud HSMs 114 to be used to perform Retail MAC processing, despite the fact that many cloud HSMs have deprecated DES functions that were previously essential to performing Retail MAC operations. Further, the process of the present invention reduces the number of HSM calls that need to be made, allowing the processing to be done more efficiently. An illustrative comparison of the optimized processing of the present invention (using cloud HSMs) to legacy processing (using HSMs that support DES) is shown below in TABLE I.

TABLE I

| Standard Retail MAC Process | Optimized Retail MAC Process |
|---|---|
| Load 2 keys: K1 and K2 | Load 2 keys: (K1K1K1) and |
| 3 HSM calls | (K1K2K1) 2 HSM calls |
| DES Call #1 (DES CBC) = | DES3 Call #1 (DES3 CBC) = |
| n core DES encryption operations | n − 1 core DES3 encryption |
| where n equals 5 in our context | operations where n equals 5 in |
| DES Call #2 (DES ECB/CBC) = | our context |
| 1 core DES decryption operation | DES3 Call #2 (DES3 CBC) = |
| DES Call #3 (DES ECB/CBC) = | 1 core DES3 encryption operation |
| 1 core DES encryption operation | |

Further, pursuant to some embodiments, additional process optimizations may also be realized which enable certain processes to be performed in parallel using different threaded operations. In particular, the processes by which key K1K1K1 and key K1K2K1 are loaded can be threaded (rather than sequential). Further, in the optimized process described above, the second DES3 call (Call #2) requires input from the first DES3 call (Call #1)—that is, Call #1 must complete before Call #2 can be executed. Embodiments utilize an improved initialization process to optimize this processing.

The logic behind the improved initialization is as follows. The first call (Call #1) involves the performance of DES3 CBC encryption using a DES3 key (K1K1K1—24 bytes) on the 32 leftmost bytes of the padded buffer and IV set to 0s (8 bytes). The second call (Call #2) involves the performance of DES3 CBC encryption using a DES3 key (K1K2K1—24 bytes) on the rightmost bytes of the padded buffer and IV set to the result of Call #1 to generate the Retail MAC value (8 bytes). Pursuant to some embodiments of the present invention, the way the second encryption is executed is changed to also use an IV set to 0's (8 bytes). In that case an XOR function (that applies for CBC between the IV and the input data) must be performed upfront on the input data.

Now, in the improved process, the list of operations will be: (i) Perform DES3 CBC encryption (Call #1) using a DES3 key (K1K1K1—24 bytes) on the 32 leftmost bytes of the padded buffer and IV set to 0s (8 bytes), (ii) Prepare buffer (8 bytes) computing XOR using (a) 8 rightmost bytes of the padded buffer and (b) 8 rightmost bytes of result of Call #1, (iii) Perform DES3 CBC encryption (Call #2) using a DES3 key (K1K2K1—24 bytes) on the buffer (XOR operation) and IV set to 0s (8 bytes) to generate the Retail MAC value (8 bytes).

Pursuant to some embodiments, this common use of an IV set to 0s (8 bytes) provides a second opportunity to optimize the process as the proprietary initialization process is agnostic of the data to be encrypted and can be performed upfront in parallel using the two threads introduced above.

The resulting list of operations becomes: (i) Key loading in the cloud HSM, (A) Load (K1K1K1), (B) Load (K1K2K1), (ii) initialize two cloud HSM 114 calls, (C1) DES3 encryption operation (CBC using IV set to 0s—8 bytes) to use K1K1K1, and (C2) DES3 encryption operation (CBC using IV set to 0s—8 bytes) to use K1K2K1, (iii) perform the two cloud HSM calls (C2) DES Call #1 (DES3 CBC)=n-1 core DES3 encryption operations where n equals 5, and (D2) DES Call #2 (DES3 CBC)=1 core DES3 encryption operation. The solution may be threaded as shown below in TABLE II.

TABLE II

| Thread #1 | Thread #2 |
|---|---|
| #A (load) | #B (load) |
| #C1 (init) | #D1 |
| #C2 (encrypt) | (init) |
| Compute XOR | |
| buffer | |

| | |
|---|---|
| [symbol] | #D2 (encrypt) can be executed when |
| | threads #1 and #2 are completed |

In general, the optimized process pursuant to the present invention allows cloud HSMs 114 to be used to perform Retail MAC processing. Further, embodiments provide optimized processing allowing portions of the process to be threaded, thereby reducing the time required for processing. Details of an illustrative example will now be provided which include sample transaction data (shown in TABLE II) and the Retail MAC generation example shown in TABLE III.

TABLE II

| Context | Details |
|---|---|
| This table shows sample data | Test vectors are using the following values: |
| for cryptogram generation in | Values from Card Profile |
| the context of DE48SE43 | (the PAN Sequence Number (1 byte): |
| cryptographic process for | dsrpPSN = 00 |
| validation is similar but not | Application Interchange Profile (AIP) |
| shown herein). | (2 bytes): dsrpAIP = 1A00 |
| | Key Derivation Index (KDI) (1 byte): |
| | dsrpKDI = 03 |
| | Cryptogram Version Number (CVN) |
| | (1 byte): dsrpCVN = 14 |
| | Static Values used for UCAF Format 0 |
| | DSRP UCAF Version (1 nibble): |
| | dsrpUCAFVersion = 0000b |
| | Amount, Authorized (Numeric) |
| | (6 bytes): dsrpAmountAuthorized = |
| | 000000000000 |
| | Amount, Other (Numeric) (6 bytes): |
| | dsrpAmountOther = 000000000000 |
| | Terminal Country Code (2 bytes): |
| | dsrpTerminalCountryCode = 0000 |
| | Transaction Currency Code (2 bytes): |
| | dsrpTransactionCurrencyCode = 0000 |
| | Transaction Date (3 bytes): |
| | dsrpTransactionDate = 000000 |
| | Transaction Type (1 byte): |
| | dsrpTransactionType =00 |
| | Card Verification Results (6 bytes): |
| | dsrpCVR = A50000000000 |
| | Transaction related information |
| | Unpredictable Number (4 bytes): |
| | dsrpUN = 45AC6F28 |

TABLE III

| Context | Details | |
|---|---|---|
| Description of | 1. | Construct a buffer using |
| optimized | | buffer = dsrpAmountAuthorized \|\| dsrpAmountOther \|\| |
| Retail MAC | | dsrpTerminalCountryCode \|\| dsrpTVR \|\| dsrpTransactionCurrencyCode \|\| |
| generation | | dsrpTransactionDate \|\| dsrpTransactionType \|\| dsrpUN \|\| dsrpAIP \|\| |
| process | | dsrpATC \|\| dsrpCVR |
| | 2. | Pad the buffer using 0 × 80 to create a 40 bytes padded buffer |
| | 3. | Perform DES3 CBC encryption using a DES3 key (K1K1K1 - 24 bytes) on the |
| | | 32 leftmost bytes of the padded buffer and IV set to 0s (8 bytes) |
| | 4. | Perform DES3 CBC encryption using a DES3 key (K1K2K1 - 24 bytes) on the |
| | | 8 rightmost bytes of the padded buffer and IV set to the result of step #2 |
| | | to generate Retail MAC value (8 bytes). |

| | |
|---|---|
| Sample data in | SK_RP_UMD = 3A6CA994AA019EA5824AD5A712A25856 |
| optimized | SK_RP_UMD can be seen as K1 \| K2 where K1 is 8 bytes left of SK_RP_UMD and |
| Retail MAC | K2 is 8 bytes right of SK_RP_UMD |
| generation | Retail MAC will be done using: |
| | Step #1: DES3 CBC Encrypt using K1K1K1 (M_1/M_2 / . . . /M_n −1 excluding |
| | rightmost 8 bytes of padded buffer) using IV set to 0s |
| | Step #2: DES3 CBC Encrypt using K1K2K1 (M_n defined as rightmost 8 |
| | bytes of padded buffer) using IV set to result of Step #1 |
| | temp = DES3 CBC Encrypt |
| | (3A6CA994AA019EA53A6CA994AA019EA53A6CA994AA019EA5)[ |
| | 0000000000000000000000000000000000000000000000000045A |
| | C6F281A0012] using IV = 0000000000000000 |
| | temp = |
| | 430D3BFFA9C924584F14BE4455B5F9980F267FE311C1BFA220C36 |
| | 0291EB7D52B |
| | Last 8 bytes of temp = 20C360291EB7D52B |
| | retailMAC = DES3 CBC Encrypt |
| | (3A6CA994AA019EA5824AD5A712A258563A6CA994AA019EA5)[ |
| | ABA5000000000080] using IV = 20C360291EB7D52B |
| | retailMAC = ED65FA43B6114D7E |
| | SK_RP_MD = 284292647694262C13887D79B6431C57 |
| | SK_RP_MD can be seen as K1 \| K2 where K1 is 8 bytes left of SK_RP_MD and |
| | K2 is 8 bytes right of SK_RP_MD |
| | Retail MAC will be done using: |
| | Step #1: DES3 CBC Encrypt using K1K1K1 (M_1/M_2/ . . . /M_n − 1 excluding |
| | rightmost 8 bytes of padded buffer) using IV set to 0s |
| | Step #2: DES3 CBC Encrypt using K1K2K1 (M_n defined as rightmost 8 |
| | bytes of padded buffer) using IV set to result of Step #1 |
| | temp = DES3 CBC Encrypt |
| | (284292647694262C284292647694262C28429264769426C)[ |
| | 0000000000000000000000000000000000000000000000000045A |
| | C6F281A0012] using IV= 0000000000000000 |
| | temp = |
| | E721D1F033F090BF993A0AD43D3E47B48C7913DB040CEF63A383E |
| | 741C485C3AA |
| | Last 8 bytes of temp = A383E741C485C3AA |
| | retailMAC = DES3 CBC Encrypt |
| | (284292647694262C13887D79B6431C57284292647694262C)[ |
| | ABA5000000000080] using IV = A383E741C485C3AA |
| | retailMAC = 3212377B8C22E54A |
| | SK_RP_UMD = 3A6CA994AA019EA5824AD5A712A25856 |
| | SK_RP_UMD can be seen as K1 \| K2 where K1 is 8 bytes left of SK_RP_UMD and |
| | K2 is 8 bytes right of SK_RP_UMD |
| | Retail MAC will be done using: |
| | Step #1: DES3 CBC Encrypt using K1K1K1 (M_1/M_2/ . . . /M_n − 1 excluding |
| | rightmost 8 bytes of padded buffer) using IV set to 0s |
| | ComputeR XOR_Buffer |
| | Step #2: DES3 CBC Encrypt using K1K2K1 (XOR_Buffer) using IV set to 0s |
| | temp = DES3 CBC Encrypt |
| | (3A6CA994AA019EA53A6CA994AA019EA53A6CA994AA019EA5)[ |
| | 0000000000000000000000000000000000000000000000000045A |
| | C6F281A0012] using IV = 0000000000000000 |
| | temp = |
| | 430D3BFFA9C924584F14BE4455B5F9980F267FE311C1BFA220C36 |
| | 0291EB7D52B |
| | Last 8 bytes of temp = 20C360291EB7D52B |
| | XOR_buffer = temp XOR M_n where M_n is defined as rightmost 8 bytes of |
| | padded buffer |
| | XOR_buffer = 20C360291EB7D52B XOR ABA5000000000080 |
| | XOR_buffer = 8B6660291EB7D5AB |
| | retailMAC = DES3 CBC Encrypt |
| | (3A6CA994AA019EA5824AD5A712A258563A6CA994AA019EA5)[ |
| | 8B6660291EB7D5AB] using IV = 0000000000000000 |
| | retailMAC = ED65FA43B6114D7E |
| | SK_RP_MD = 284292647694262C13887D79B6431C57 |
| | SK_RP_MD can be seen as K1 \| K2 where K1 is 8 bytes left of SK_RP_MD and |
| | K2 is 8 bytes right of SK_RP_MD |
| | Retail MAC will be done using: |
| | Step #1: DES3 CBC Encrypt using K1K1K1 (M_1/M_2/ . . . /M_n −1excluding |
| | rightmost 8 bytes of padded buffer) using IV set to 0s |
| | Compute XOR Buffer |
| | Step #2: DES3 CBC Encrypt using K1K2K1 (XOR_Buffer) using IV set to 0s |
| | temp = DES3 CBC Encrypt |
| | (284292647694262C284292647694262C284292647694262C)[ |
| | 0000000000000000000000000000000000000000000000000045A |
| | C6F281A0012] using IV = 0000000000000000 |
| | temp = |
| | E721D1F033F090BF993A0AD43D3E47B48C7913DB040CEF63A383E |
| | 741C485C3AA |
| | Last 8 bytes of temp = A383E741C485C3AA |
| | XOR_buffer = temp XOR M_n where M_n is defined as rightmost 8 bytes of |
| | padded buffer |
| | XOR_buffer = A383E741C485C3AA XOR ABA5000000000080 |
| | XOR_buffer= 0826E741C485C32A |
| | retailMAC = DES3 CBC Encrypt |
| | (284292647694262C13887D79B6431C57284292647694262C[ |
| | 0826E741C485C32A] using IV = 0000000000000000 |
| | retailMAC = 3212377B8C22E54A |

The flow charts and transaction flows described herein do not imply a fixed order to the steps, and embodiments of the present invention may be practiced in any order that is practicable. Although some figures use numbers to indicate a sequence of steps, those steps are illustrative and may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

The embodiments described herein may be implemented using any number of different hardware configurations. Embodiments described herein may be implemented in hardware, in a computer program executed by a processor, in firmware, or in a combination of the above. A computer program may be embodied on a computer readable medium, such as a storage medium or storage device. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

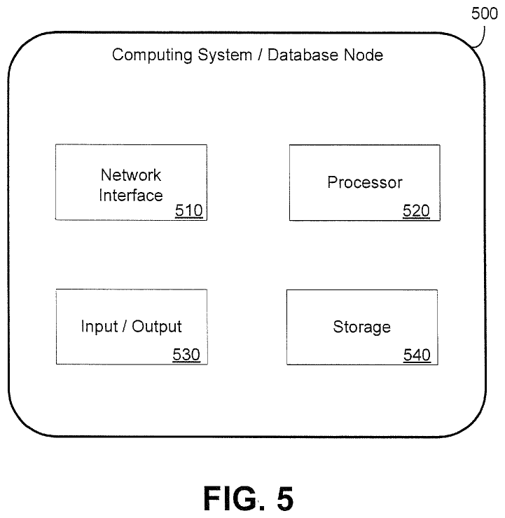

A storage medium may be coupled to the processor such that the processor may read information from, and write information to, the storage medium. In an alternative, the storage medium may be integral to the processor. The processor and the storage medium may reside in an application specific integrated circuit (“ASIC”). In an alternative, the processor and the storage medium may reside as discrete components. For example, FIG. 5 illustrates an example computing system 500 which may represent or be integrated in any of the above-described components (such as, for example, the payment server 104, the merchant server 106, the device 102, etc.). FIG. 5 is not intended to suggest any limitation as to the scope of use or functionality of embodiments described herein. The computing system 500 is capable of being implemented and/or performing any of the functionality set forth hereinabove.

The computing system 500 may include a computer system/server, which is operational with numerous other general-purpose or special purpose computing system environments or configurations. Examples of well-known computing systems, environments, and/or configurations that may be suitable for use as computing system 500 include, but are not limited to, personal computer systems, server computer systems, thin clients, thick clients, hand-held or laptop devices, tablets, smart phones, databases, multiprocessor systems, microprocessor-based systems, set top boxes, programmable consumer electronics, network PCs, minicomputer systems, mainframe computer systems, distributed cloud computing environments, databases, and the like, which may include any of the above systems or devices, and the like.

The computing system 500 may be described in the general context of computer system-executable instructions, such as program modules, being executed by a computer system. Generally, program modules may include routines, programs, objects, components, logic, data structures, and so on that perform particular tasks or implement particular abstract data types. The computing system 500 may be practiced in distributed cloud computing environments where tasks are performed by remote processing devices that are linked through a communications network. In a distributed cloud computing environment, program modules may be located in both local and remote computer system storage media including memory storage devices.

Referring to FIG. 5, the computing system 500 is shown in the form of a general-purpose computing device. The components of computing system 500 may include, but are not limited to, a network interface 510, one or more processors or processing units 520, an output 530 which may include a port, an interface, etc., or other hardware, for outputting a data signal to another device such as a display, a printer, etc., and a storage device 540 which may include a system memory, or the like. Although not shown, the computing system 500 may also include a system bus that couples various system components including system memory to the processor 520.

The storage device 540 may include a variety of computer system readable media. Such media may be any available media that is accessible by computer system/server, and it may include both volatile and non-volatile media, removable and non-removable media. System memory, in one embodiment, implements the flow diagrams of the other figures. The system memory can include computer system readable media in the form of volatile memory, such as random-access memory (RAM) and/or cache memory. As another example, storage device 540 can read and write to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, storage device 540 may include at least one program product having a set (e.g., at least one) of program modules that are configured to carry out the functions of various embodiments of the application.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Although not shown, the computing system 500 may also communicate with one or more external devices such as a keyboard, a pointing device, a display, etc.; one or more devices that enable a user to interact with computer system/server; and/or any devices (e.g., network card, modem, etc.) that enable computing system 500 to communicate with one or more other computing devices. Such communication can occur via I/O interfaces. Further, computing system 500 can communicate with one or more networks such as a local area network (LAN), a general wide area network (WAN), and/or a public network (e.g., the Internet) via network interface 510. As depicted, network interface 510 may also include a network adapter that communicates with the other components of computing system 500 via a bus. Although not shown, other hardware and/or software components could be used in conjunction with the computing system 500. Examples include, but are not limited to: microcode, device drivers, redundant processing units, external disk drive arrays, RAID systems, tape drives, and data archival storage systems, etc.

Pursuant to some embodiments, the computing system 500 may be a user device (e.g., such as a mobile phone, tablet computer, personal computer or the like) operated by a user to display from a merchant website during a purchase transaction involving the secure remote commerce system of the present invention.

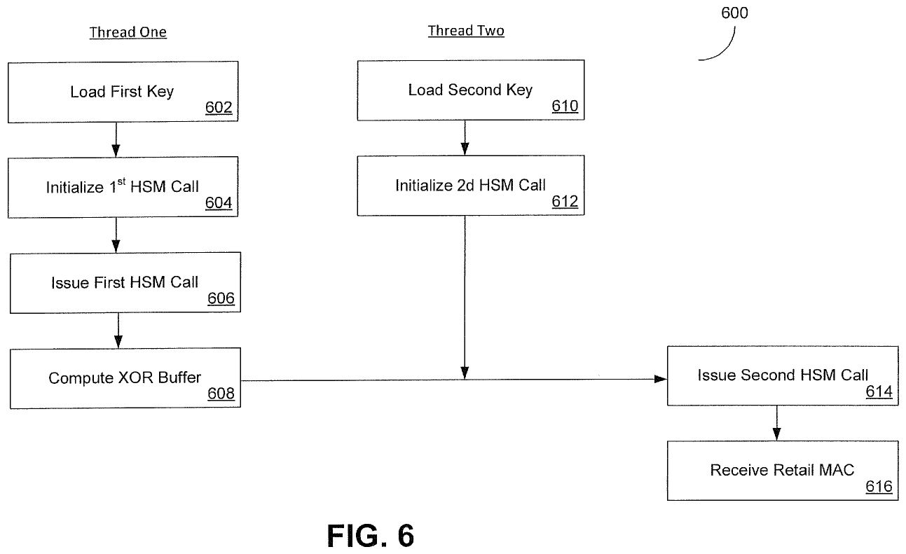

Reference is now made to FIG. 6 where a flow diagram depicting an optimized Retail MAC process 600 pursuant to the present invention is shown. The process 600 allows Retail MAC processing to be performed on cloud HSMs including those that have deprecated certain DES cryptographic processes. Further, some embodiments provide improved performance using threaded operations. The process 600 begins at 602 and 610 (in two threaded operations that may be executed substantially in parallel) where a first key is loaded 602 and a second key is loaded 610. For example, the first and second keys may be loaded into a Java application associated with (or in communication with) the cloud HSM 114 (or the cloud HSM cluster). In the first thread, processing continues at 604 where the first encryption call is prepared. For example, as discussed above, the first encryption call may be prepared by using the input data set to 0's (eight bytes) and to use the first key. Processing in the first thread continues at 606 where the first HSM call is made. More particularly, a DES3 encryption call is made to the cloud HSM 114 (using CBC mode of operation).

In the second thread, processing continues at 612 where the second HSM call is initialized. In the first thread, the response from the first HSM call is used in an XOR buffer using the eight rightmost bytes of the padded buffer and the eight rightmost bytes of the results from the first HSM call. Now, the first and second thread converge and processing continues at 614 where the data from the XOR buffer and the initialized second HSM call are used to issue the second HSM call. More particularly, a DES3 encryption call is made to the cloud HSM 114 (using CBC mode of operation). The resulting Retail MAC code is received at 616 and may be used for further processing in support of a transaction (such as a payment transaction as described herein).

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A computer-implemented method to generate a retail message authentication code (MAC), the method comprising:
loading a first key;
loading a second key;
issuing a first call to a cloud hardware security module (HSM) to invoke a DES3 encryption operation, the call including the first key and a first input set of data;
receiving an output of the first call;
issuing a second call to a cloud HSM to invoke a DES3 encryption operation, the call including the second key and a second input set of data, the second input set of data including data associated with the output of the first call; and
receiving the generated retail MAC.

2. The computer-implemented method of claim 1, further comprising:
creating the first input set of data prior to issuing the first call, the first input set of data includes data associated with a payment transaction; and
creating the second input set of data prior to issuing the second call.

3. The computer-implemented method of claim 2, further comprising:
initiating a first threaded operation, the first threaded operation including loading the first key, creating the first input set of data, issuing the first call, receiving the output of the first call and obtaining the data associated with the output of the first call.

4. The computer-implemented method of claim 3, further comprising:
initiating a second threaded operation, the second threaded operation including loading the second key and creating the second input set of data.

5. The computer-implemented method of claim 4, further comprising:
issuing the second call after completion of the first and second threaded operations.

6. The computer-implemented method of claim 2, wherein the data associated with a payment transaction includes at least one of data associated with a transaction amount, a currency code, a transaction date, an unpredictable number, a transaction type, and a card verification result.

7. The computer-implemented method of claim 2, wherein the retail MAC is used to authenticate the payment transaction.

8. The computer-implemented method of claim 2, wherein the retail MAC is used to generate an application cryptogram associated with the payment transaction.

9. The computer-implemented method of claim 2, wherein the retail MAC is used to validate an application cryptogram associated with the payment transaction.

10. The computer-implemented method of claim 1, wherein the first and second calls to the cloud HSM are triple data encryption standard (DES3) encryption request using a cipher block chaining (CBC) mode of operation.

11. A system to generate a retail message authentication code (MAC), comprising:
a first communication port to exchange information associated with a remote hardware security module (HSM);
an processing system, coupled to the first communication port, including a computer processor a memory storing instructions to cause the computer processor to:
load a first key;
load a second key;
issue a first call to a cloud hardware security module (HSM) to invoke a DES3 encryption operation, the call including the first key and a first input set of data;
receive an output of the first call;
issue a second call to a cloud HSM to invoke a DES3 encryption operation, the call including the second key and a second input set of data, the second input set of data including data associated with the output of the first call; and
receive the generated retail MAC.

12. The system of claim 11, wherein the instructions further cause the computer processor to:
create the first input set of data prior to issuing the first call, the first input set of data includes data associated with a payment transaction; and
create the second input set of data prior to issuing the second call.

13. The system of claim 12, wherein the instructions further cause the computer processor to:
initiate a first threaded operation, the first threaded operation including loading the first key, creating the first input set of data, issuing the first call, receiving the output of the first call and obtaining the data associated with the output of the first call.

14. The system of claim 13, wherein the instructions further cause the computer processor to:
initiate a second threaded operation, the second threaded operation including loading the second key and creating the second input set of data.

15. The system of claim 14, wherein the instructions further cause the computer processor to:
issue the second call after completion of the first and second threaded operations.

16. The system of claim 11, wherein the first and second calls to the cloud HSM are triple data encryption standard (DES3) encryption request using a cipher block chaining (CBC) mode of operation.

17. A non-tangible, computer-readable medium storing instructions, that, when executed by a processor, cause the processor to perform a method to generate a retail message authentication code (MAC), the method comprising:
loading a first key;
loading a second key;
issuing a first call to a cloud hardware security module (HSM) to invoke a DES3 encryption operation, the call including the first key and a first input set of data;
receiving an output of the first call;
issuing a second call to a cloud HSM to invoke a DES3 encryption operation, the call including the second key and a second input set of data, the second input set of data including data associated with the output of the first call; and
receiving the generated retail MAC.
